(19) United States
(12) Patent Application Publication
(10) Pub. No.: US 2007/0222177 A1
(43) Pub. Date: Sep. 27, 2007

(54) Bicycle head assembly

(76) Inventor: Douglas Chiang, Taichung Hsien (TW)

Correspondence Address: Douglas Chiang, 235 Chung-Ho, Box 8-24, Taipei, TW

(21) Appl. No.: 11/368,151

(22) Filed: Mar. 6, 2006

(51) Int. Cl. B62K 1/00

(52) U.S. Cl. 280/280

(57) ABSTRACT

A bicycle head assembly comprises an assembly seat; a bearing being installed in the assembly seat; an inner side of the bearing being rotatably installed with a stand tube of a bicycle; a washer formed by winding a substrate through several circles so as to have a form of a spring; thereby the washer being elastic and compressible; the washer being received into the assembly seat so as to position the bearing and thus the bearing is combined into the assembly seat. All cycles of the washer have a same diameter, or the washer has a tapered shape. The substrate is a flat and long substrate.

### FIELD OF THE INVENTION

The present invention relates to bicycles, and particularly to a bicycle head assembly, wherein a washer used to assembly a bearing to an assembly seat of a bicycle so as to have a stable structure. Thereby the assembly of the present invention is easy and convenient.

### BACKGROUND OF THE INVENTION

Bicycles are a popular and practical exercise tool. Thereby there are more and more peoples riding bicycles as exercise and as a daily life tool. However about the safety driving of a bicycle, the assembly seat unit assembled to a front tube, a front biforked unit and a stand tube of a bicycle is a very important assembly in safety operation. Thus, the design of the assembly seat unit requires that the assembly seat unit has a simple structure and can be operated easily.

Referring to FIGS. 7 to 9, the prior art assembly seat is illustrated. In the prior art, the assembly seat unit 90 mainly includes an assembly seat 91, a bearing 92 and a washer 93. The assembly seat 91 is engaged to the front tube 9 of a bicycle. The bearing 92 is engaged to the assembly seat 91. The washer 93 serves to enforce the bearing 92 to the assembly seat 91. The washer 93 has the effect of enforcing the bearing 92. Therefore, the washer 93 has a tapered surface 94. A washer 93 has a slit 95 for providing a compressible space as the bearing 92 is enforced.

However when this prior art assembly seat unit 90 is applied to an upper seat or a lower seat, the stress is concentrated at an opposite side of the slit 95. Thereby the washer 93 is easily deformable and lose of elasticity, even the washer 93 can effectively enforce the bearing 92 to the assembly seat 91. Furthermore, referring to FIG. 9, after assembling the assembly seat unit 90, the washer 93 cannot be steadily retained to the assembly seat 91. However this will have bad affects to the operation of the bicycle. As a whole, the prior art assembly seat unit is not practical and cannot assure a safety driving.

### SUMMARY OF THE INVENTION

Accordingly, the primary object of the present invention is to provide a bicycle head assembly, wherein the washer used to assembly the bearing to the assembly seat has a stable structure. Thereby the assembly of the present invention is easy and convenient.

To achieve above objects, the present invention provides a bicycle head assembly which comprises an assembly seat; a front end of the assembly seat having a pivotal portion the diameter thereof being smaller than that of the assembly seat; the pivotal portion being received into a front tube of a bicycle; a bearing being installed in the assembly seat; an inner side of the bearing being rotatably installed with a stand tube of a bicycle; a washer being formed by winding a flat and long substrate through several circles so as to have a form of a spring; thereby the washer being elastic and compressible; the washer being received into the assembly seat so as to position the bearing and thus the bearing is combined into the assembly seat. Each cycles of the washer has a same diameter, or the washer has a tapered shape. The substrate is a flat and long substrate.

The various objects and advantages of the present invention will be more readily understood from the following detailed description when read in conjunction with the appended drawing.

### BRIEF DESCRIPTION OF THE DRAWINGS

FIG. 1 is an exploded perspective view of the bicycle head assembly of the present invention.

FIG. 2 is a schematic cross sectional view of the bicycle head assembly of the present invention.

FIG. 3 is a schematic cross sectional view of the bicycle head assembly of the present invention after assembly.

FIG. 4 is an exploded perspective view of the second embodiment of the present invention.

FIG. 5 is a schematic cross view of the second embodiment of the present invention.

FIG. 6 is a schematic cross sectional view of the second embodiment of the present invention after assembly.

FIG. 7 is an exploded perspective view of the prior art.

FIG. 8 is a schematic cross view of the prior art.

FIG. 9 is a schematic cross view of the prior art.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

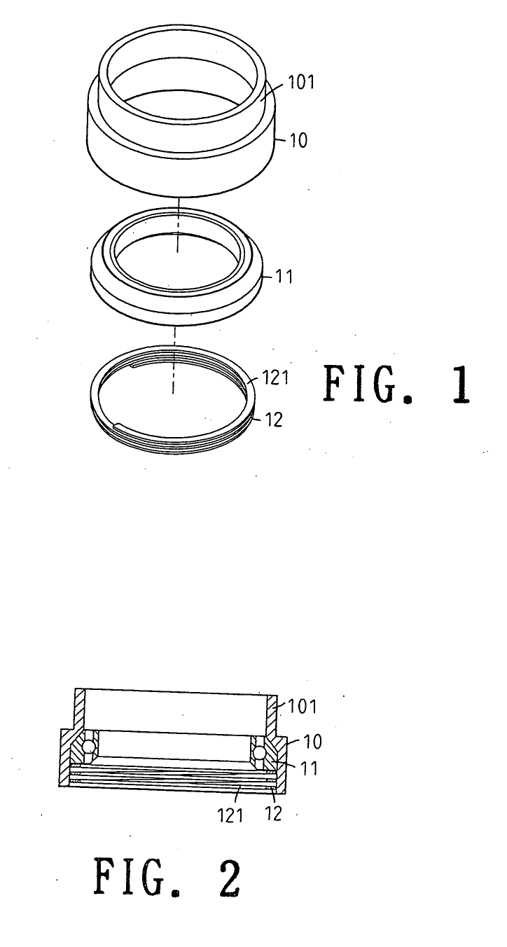

Referring to FIGS. 1 to 3, the present invention has the following elements.

An assembly seat 10 is included. A front end of the assembly seat 10 has a pivotal portion 101 the diameter thereof is smaller than that of the assembly seat 10. The pivotal portion 101 can be received into a front tube 20 of a bicycle.

A bearing 11 is installed in the assembly seat 10. An inner side of the bearing 11 is rotatably installed with a stand tube 21 of a bicycle.

A washer 12 is formed by winding a flat and long substrate 121 through several circles so as to have a form of a spring. Thereby the washer 12 is elastic and compressible. The washer 12 can be received into the assembly seat 10 so as to position the bearing 11 and thus the bearing 11 is combined into the assembly seat 10. In this embodiment, all the cycles of the washer 12 have the same diameters to have a shape of a cylinder.

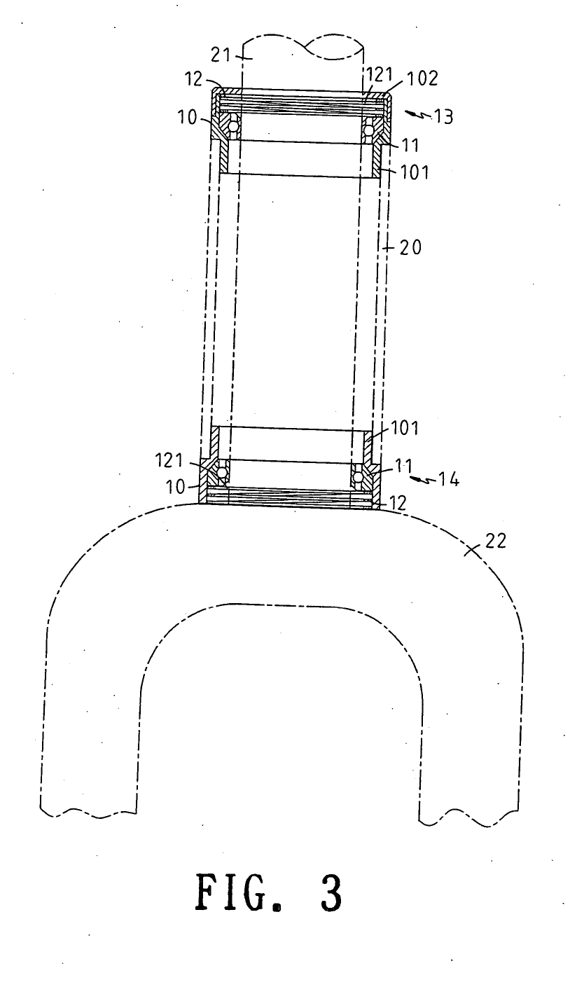

In this embodiment, the structure of the washer 12 serving to enforce the bearing 11 into the assembly seat 10 can be used to an upper seat 13 and lower seat 14 of the assembly seat 10. Referring to FIG. 3, when the structure is applied to the upper seat 13, the pivotal portion 101 is installed at a lower side of the upper seat 13. An outer upper side of the upper seat 13 has a reduced diameter for installing an outer cover 102. The pivotal portion 101 is engaged to an upper end of the front tube 20 of a bicycle. The stand tube 21 of the bicycle is inserted into the assembly seat 10 to be engaged to the bearing 11 of the assembly seat 10. Thereby the stand tube 21 of the bicycle is pivotally connected to the front tube 20 of the bicycle through the bearing 11 of the assembly seat 10.

When the structure is assembled to a lower seat 14, the assembly seat 10 is engaged to a lower end of the front tube 20 of the bicycle. Similarly, the bearing 11 of the assembly seat 10 is combined to the stand tube 21 of the bicycle. Thereby the stand tube 21 is rotatably connected to the front tube 20. A lower end of the assembly seat 10 resists against a front biforked unit 22 of the bicycle.

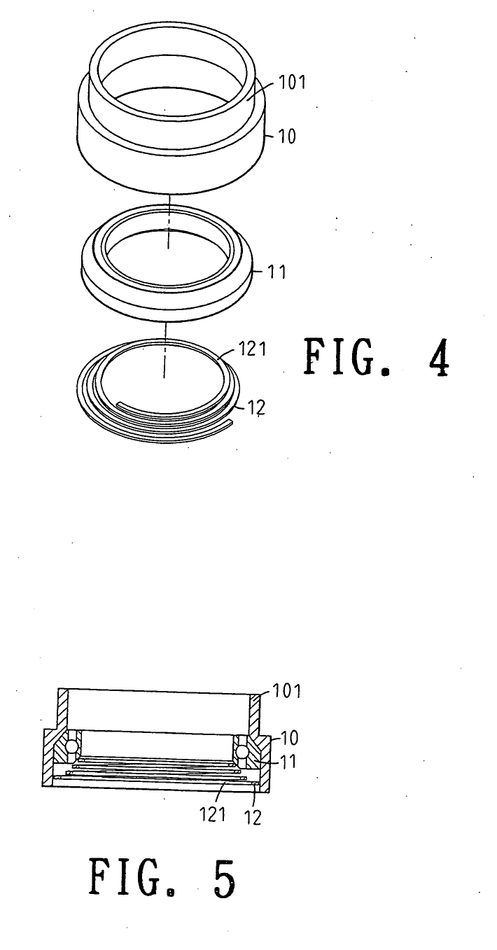

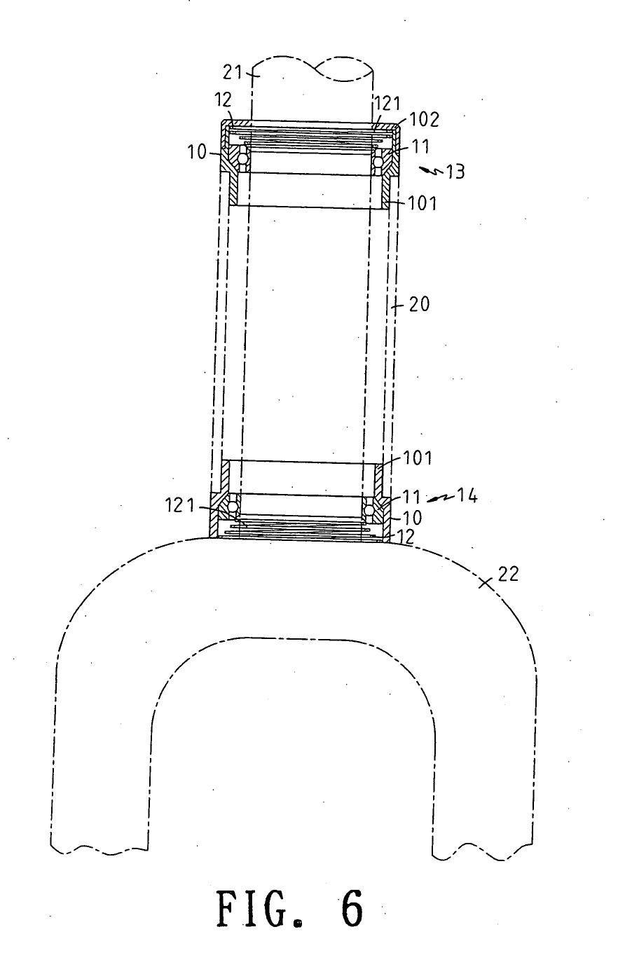

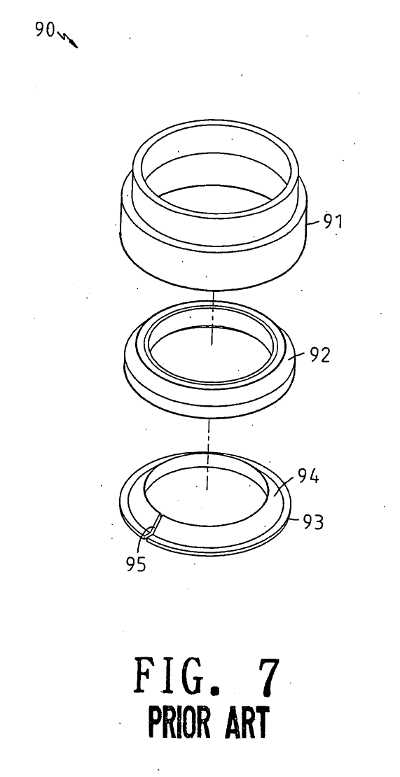

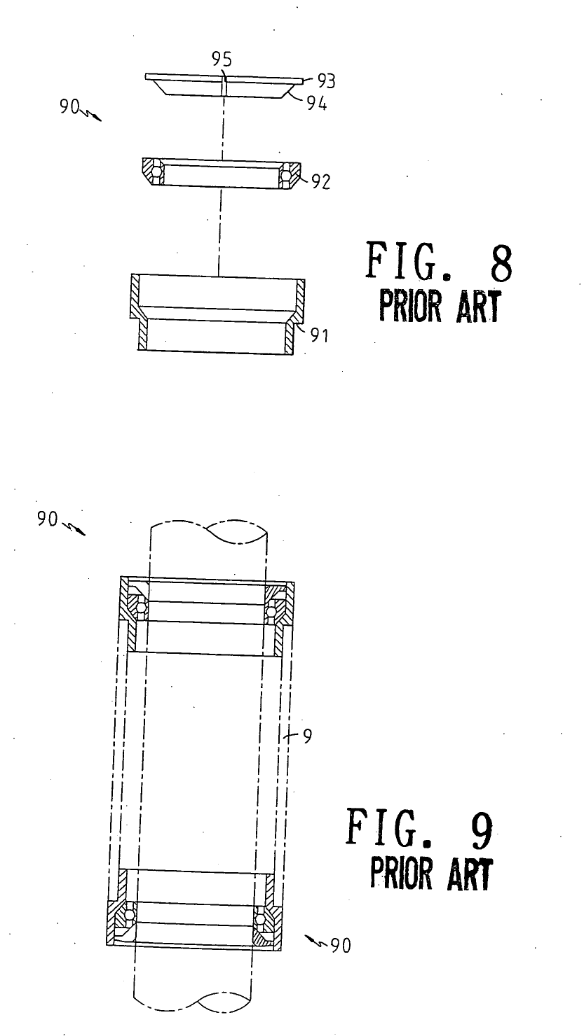

Referring to FIGS. 4 to 6, the second embodiment of the present invention is illustrated. Those identical to the above mentioned embodiment will not be described herein. Only those different are described. In this embodiment, the washer 12 has a taper shape, that is, the diameters of the cycles of the washer 12 are reduced from one cycle to another adjacent cycle.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A bicycle head assembly comprising;
an assembly seat;
a bearing being installed in the assembly seat; an inner side of the bearing being rotatably installed with a stand tube of a bicycle;
a washer formed by winding a substrate through several circles so as to have a form of a spring; thereby the washer being elastic and compressible;
the washer being received into the assembly seat so as to position the bearing and thus the bearing being combined into the assembly seat.

2. The bicycle head assembly as claimed in claim 1, wherein all cycles of the washer has a same diameter.

3. The bicycle head assembly as claimed in claim 1, wherein the washer has a tapered shape.

4. The bicycle head assembly as claimed in claim 1, wherein the substrate is a flat and long substrate.

5. A bicycle head assembly comprising:
an assembly seat; a front end of the assembly seat having a pivotal portion the diameter of which is smaller than that of the assembly seat; the pivotal portion being received into a front tube of a bicycle;
a bearing being installed in the assembly seat; an inner side of the bearing being rotatably installed with a stand tube of a bicycle;
a washer being formed by winding a flat and long substrate through several circles so as to have a form of a spring; thereby the washer being elastic and compressible; the washer being received into the assembly seat so as to position the bearing and thus the bearing is combined into the assembly seat.

6. The bicycle head assembly as claimed in claim 5, wherein each cycles of the washer has a same diameter.

7. The bicycle head assembly as claimed in claim 5, wherein the washer has a tapered shape.

8. The bicycle head assembly as claimed in claim 5, wherein the substrate is a flat and long substrate.
